(19) United States
(12) Patent Application Publication
(10) Pub. No.: US 2007/0033013 A1
(43) Pub. Date: Feb. 8, 2007

(54) Audio decoding device

(75) Inventors: Takeshi Fujita, Osaka (JP); Ichiro Kawashima, Osaka (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/349,886

(22) Filed: Feb. 9, 2006

(30) Foreign Application Priority Data
Jul. 22, 2005 (JP) 2005-212586

(51) Int. Cl. G10L 21/00

(52) U.S. Cl. 704/212

(57) ABSTRACT

An audio decoding device includes a decoding section for decoding an audio bit stream to generate PCM data and outputting input channel configuration information, a control section for receiving input channel configuration information, normalization method instruction information, externally specified normalization coefficient information and output control information and controlling internal processing, and an audio processing section for performing audio processing to PCM data. The normalization processing section performs normalization processing using the externally specified normalization coefficient information when the normalization method instruction information indicates external specification. The audio processing section performs normalization processing using the input channel configuration information and the output control information when the normalization method instruction information indicates internal calculation.

### BACKGROUND OF THE INVENTION

The present invention relates to digital signal processing techniques in a broad sense, and particularly relates to an audio decoding device for receiving a digital audio signal from the outside, performing various audio processings such as audio sound-field processing, downmixing and bass decoding, and outputting PCM data to the outside.

In recent years, multi-channel environment for DVD and the like have been widely spread. For example, the number of systems for decoding three or more channel digital audio has been increased. Audio recorded on a DVD is, in general, 5.1 channel digital audio. To correctly decode such 5.1 channel digital audio, five speakers and a bass woofer are needed. Furthermore, each of the five speakers is required to be capable of correctly decoding bass components.

However, it is difficult to provide such a speaker set in each ordinary household. Therefore, most DVD players have the function of decoding all audio without dropout even though each of the DVD players includes a less than 5.1 channel speaker set. With use of this function, a plurality of audio channels undergo mixing process so that audio output from each speaker is decoded by less speakers than those of a 5.1 channel system. By this processing, recorded audio can be decoded without dropout although a sound-field is different from an original sound-field.

In the case of a small-size speaker and the like, i.e., when each speaker does not have the ability to correctly decode bass components, a method in which all bass components are aggregated in a sub-woofer and then are output or like method is used. This technique utilizes the fact that human does not have ability to localize bass components.

The processing of mixing a plurality of channel data is widely used not only in the case where all audio are decoded using a small number of speakers but also, for example, in the case where the processing of falsely forming a sound-field.

When audio processing such as audio sound-field processing, downmixing and bass decoding is performed, adding operation and product-sum operation of a plurality of channel data are performed. However, there is a maximum value for PCM data to be presented, and therefore, when adding operation of a plurality of channel data is performed, the maximum value which can be digitally represented might be exceeded. PCM data with a value exceeding the maximum value can be perceived as harsh noise if it is left as it is. Therefore, in general, clipping of replacing an overflow value with a positive or negative maximum value is performed. Noise can be avoided by clipping but audio is distorted.

To avoid this, before performing audio processing, an optimum, normalization coefficient is calculated in advance and all channels of PCM data are uniformly attenuated by normalization, so that digital overflow does not occur during data adding operation. The reason why all channels are uniformly attenuated by normalization is that if only a specific channel is attenuated, level differences are generated among different channels.

When PCM data is attenuated, the volume of a final output becomes small. Therefore, to obtain a certain audibility level even different cases, it is desirable to correct levels in an analog signal amplifying circuit to which an audio decoding device outputs data. That is, after PCM data has been analog-converted by a D/A converter, a volume has to be increased using an analog amplifier.

A normalization level which is needed in an audio processing section varies according to output control information such as an input channel configuration, audio processing, playback conditions of a speaker and the like. Accordingly, each time when an operation state of a system is changed, a normalization level in an audio processing section has to be calculated and an amount of amplification has to be adjusted in an analog signal amplifying circuit to which the audio decoding device outputs data.

As a method for achieving an audio decoding device, a semiconductor device such as a digital signal processor and a system LSI is used in many cases. In such a case, the following three problems tend to arise.

First, processing performed by a digital signal processor differs depending on a product and thus calculation of an amplification amount to be set for an analog amplifier is not easy. A control system is complicated and, furthermore, a system has to be reconstructed in each case where a different digital signal processor is used. Therefore, costs for development of circuit design and control system are increased.

Second, a normalization level is changed depending on a timing of processing preformed by a digital signal processor and, furthermore, there is a delay time from a processing performed by the digital signal processor to a processing performed by the analog amplifier. Therefore, it becomes difficult to perform a control operation in real time.

Third, when the digital signal processor have a plurality of audio processing functions, internal parameters vary in a complicated manner according to input conditions. Accordingly, it becomes extremely difficult to understand processing performed by the digital signal processor from the outside.

### SUMMARY OF THE INVENTION

The present invention has been devised in view of the above-described problems. It is therefore an object of the present invention is to provide an audio decoding device which can perform optimum normalization without complicating control of an analog signal amplifying circuit to which the audio decoding device even when various input and playback conditions are processed.

To achieve the above-described object, an audio decoding device according to the present invention selects a normalization condition, based on normalization method instruction information. According to the selected condition, selection about which a normalization coefficient is externally set or a normalization coefficient is automatically calculated is made.

With the audio decoding device, settings for normalization processing can be changed according to a configuration and a cost condition of a system in which the audio decoding device is implemented.

### BRIEF DESCRIPTION OF THE DRAWINGS

FIG. 1 is a block diagram illustrating an exemplary configuration of an audio decoding device according to a first embodiment of the present invention.

FIG. 2 is a table showing an exemplary configuration of normalization method instruction information in FIG. 1.

FIG. 3 is a flowchart illustrating process steps of a decoding section of FIG. 1.

FIG. 4 is a flowchart illustrating process steps of a normalization processing section of FIG. 1.

FIG. 5 is a flowchart illustrating process steps of an audio processing section of FIG. 1.

FIG. 6 is a table showing examples of optimum normalization coefficients used in downmixing of the audio decoding device of FIG. 1.

FIG. 7 is a block diagram illustrating an exemplary configuration of an audio decoding device according to a second embodiment of the present invention.

FIG. 8 is a table showing exemplary normalization method instruction information in FIG. 7.

FIG. 9 is a flowchart illustrating process steps of an audio processing section of FIG. 7.

FIG. 10 is a block diagram illustrating an exemplary configuration of an audio decoding device according to a third embodiment of the present invention.

FIG. 11 is a table showing an example of normalization method instruction information in FIG. 10.

FIG. 12 is a flowchart illustrating process steps of a control section of FIG. 10.

FIG. 13 is a flowchart illustrating process steps of a normalization processing section of FIG. 10.

FIG. 14 is a flowchart illustrating process steps of a first audio processing section of FIG. 10.

FIG. 15 is a flowchart illustrating process steps of a second processing section of FIG. 10.

FIG. 16 is a block diagram illustrating an exemplary configuration of an audio decoding device according to a fourth embodiment of the present invention.

FIG. 17 is a flowchart illustrating process steps of a control section of FIG. 16.

FIG. 18 is a flowchart illustrating process steps of a first audio processing section of FIG. 16.

FIG. 19 is a flowchart illustrating process steps of a second audio processing section of FIG. 16.

### DESCRIPTION OF THE PREFERRED EMBODIMENTS

Hereafter, embodiments of the present invention will be described with reference to the accompanying drawings.

### First Embodiment

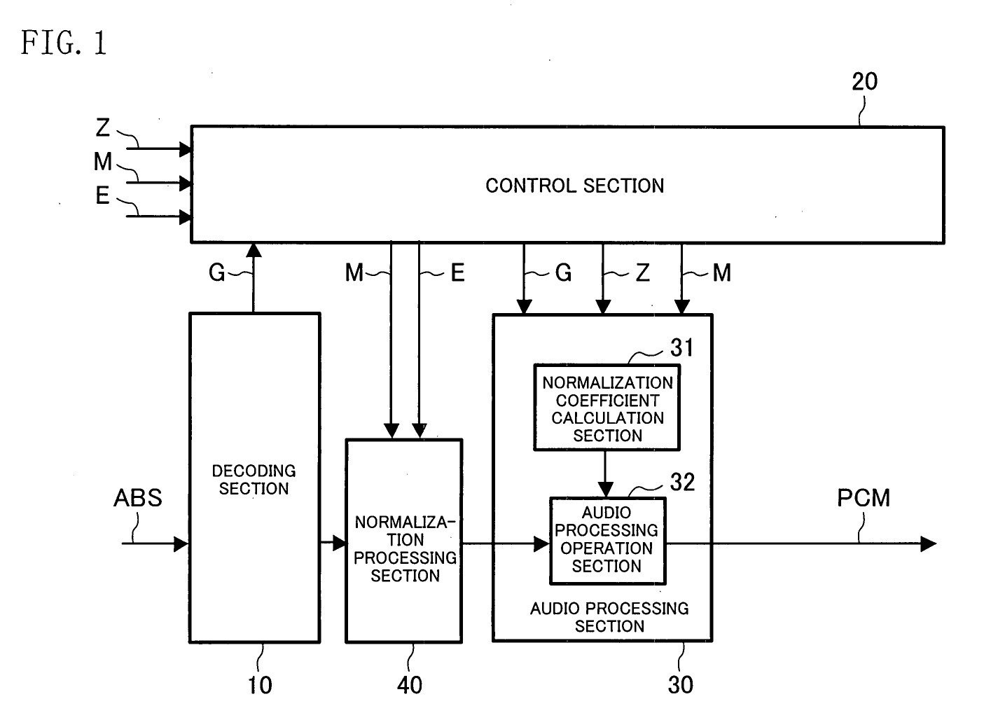

FIG. 1 is a block diagram illustrating an exemplary configuration of an audio decoding device according to a first embodiment of the present invention. The audio decoding device of FIG. 1 includes a decoding section 10, a control section 20, a normalization processing section 40 and an audio processing section 30.

The decoding section 10 has the function of decoding an audio bit stream (ABS) input from the outside to generate PCM data, outputting the PCM data to the normalization processing section 40 and transmitting as input channel configuration information G channel configuration information for the decoded PCM data which has been obtained from header information analysis or like processing in decoding the audio bit stream to the control section 20.

The control section 20 has the function of receiving output control information Z, normalization method instruction information M and externally specified normalization coefficient information E from the outside and input channel configuration information G from the decoding section 10 and transmitting the received information to the normalization processing section 40 and the audio processing section 30. The output control information Z includes, for example, channel information for speakers connected to an analog signal amplifying circuit to which data is output, bass management information and various kinds of settings for the audio processing section 30. The normalization method instruction information M is information for indicating which a volume normalization coefficient is implemented in internal operation processing before performing audio processing or an externally specified coefficient is used. The externally specified normalization coefficient information E is level data for volume normalization processing used when an externally specified normalization coefficient is selected by the normalization method instruction information M.

The normalization processing section 40 has the function of receiving the normalization method instruction information M and externally specified normalization coefficient information E from the control section 20 and performing normalization processing to PCM data output from the decoding section 10 according to an instruction of the normalization method instruction information M.

The audio processing section 30 is formed so as to include a normalization coefficient calculation section 31 and an audio processing operation section 32 inside thereof. The audio processing section 30 has the function of receiving input channel configuration information G, output control information Z and normalization method instruction information M, calculating, when an internal calculation of a normalization coefficient is specified by the normalization method instruction information M, a normalization coefficient in the normalization coefficient calculation section 31 and then performing audio processing such as audio sound-field processing, downmixing and bass decoding in the audio processing operation section 32.

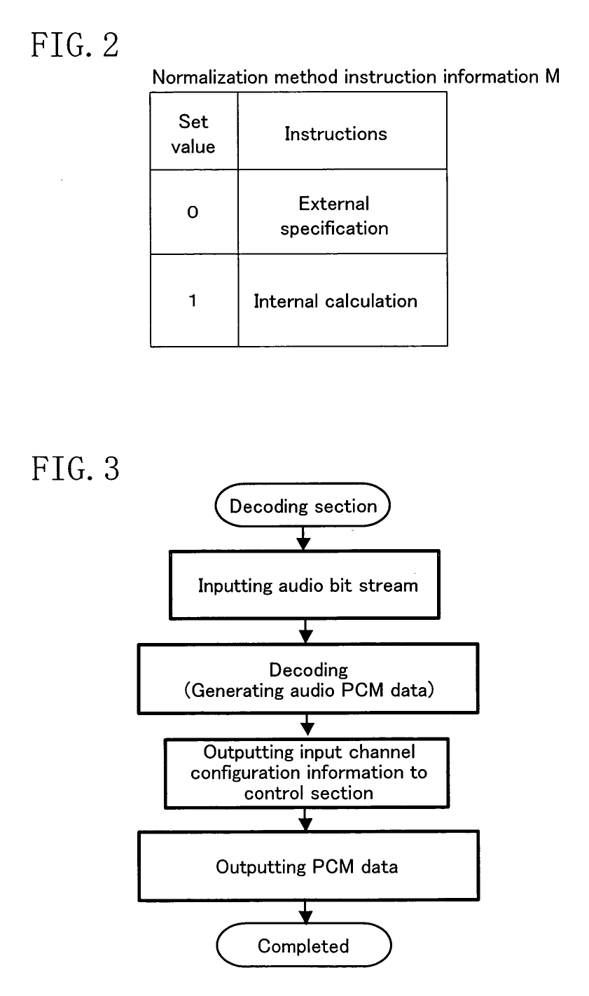

FIG. 2 is a table showing an example of instructions for each set value, specified by the normalization method instruction information M in this embodiment. According to FIG. 2, if the set value is 0, “external specification” is indicated, and if the set value is 1, “internal calculation” is indicated.

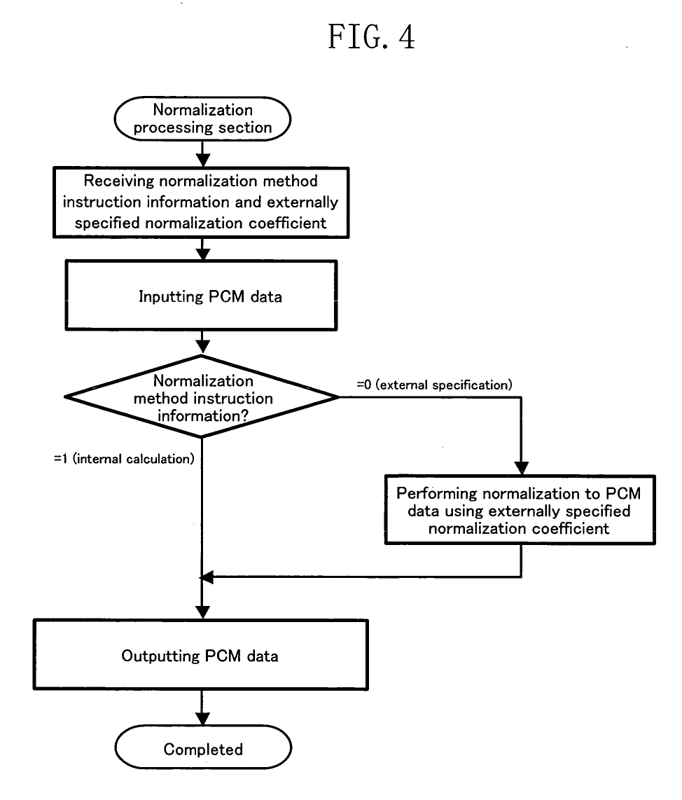

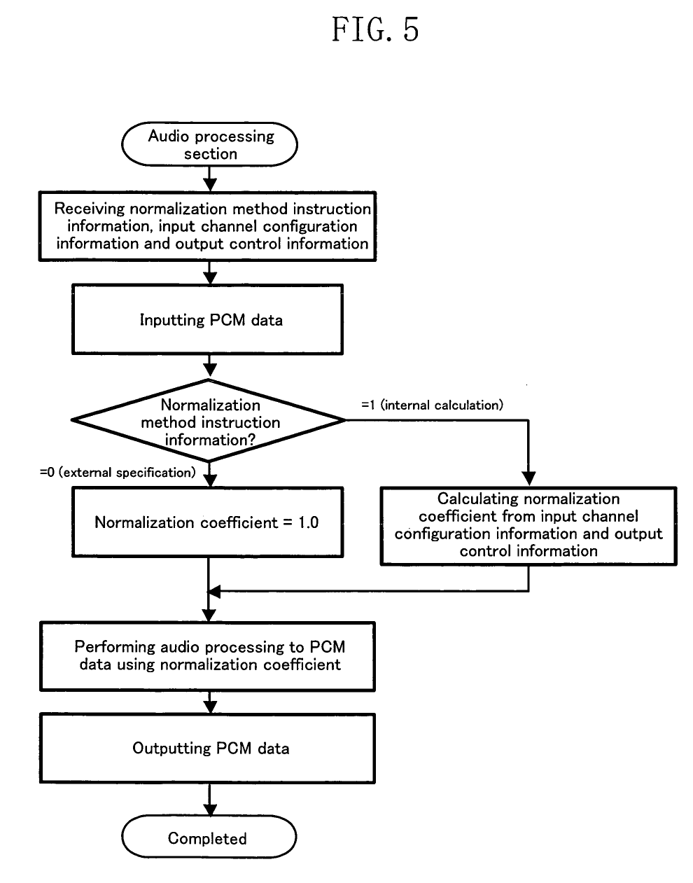

FIGS. 3 through 5 are flowcharts showing the outline of process steps according to this embodiment. FIG. 3 shows process steps performed by a decoding section 10. FIG. 4 shows process steps performed by the normalization processing section 40. FIG. 5 shows process steps performed by the audio processing section 30.

In this embodiment, for the sake of simplification, it is assumed that in the audio decoding device of FIG. 1, audio processing performed in the audio processing section 30 is downmixing and output control information Z is information showing output channel configuration. The case where input channel configuration information indicates 5 channels (L/R/C/LS/RS), the output control information (output channel configuration) shows 3 channels (L/R/C) and the external specified normalization coefficient is 2.4 will be described with reference to the flowcharts of FIGS. 3 through 5.

1) The case where a set value of the normalization method instruction information M is “0 (external specification)”

First, in the decoding section 10, an externally input audio bit stream is decoded to generate PCM data. The channel configuration of the decoded PCM data includes 5 channels (L/R/C/LS/RS). This information is obtained from header information analysis or like processing when the audio bit stream is decoded and is transmitted to the control section 20 as input channel configuration information G. The decoded PCM data is output to the normalization processing section 40.

The control section 20 receives output channel configuration information, i.e., the output control information Z, the normalization method instruction information M and the externally specified normalization coefficient information E from the outside and the input channel configuration information G from the decoding section 10. Then, the data of the above-described information is transmitted to the normalization processing section 40 and the audio processing section 30.

In the normalization processing section 40, the normalization method instruction information M and the externally specified normalization coefficient information E are received from the control section 20. In this case, the normalization method instruction information M is “0”, and thus normalization processing using an externally specified coefficient is instructed. Accordingly, the entire PCM data input from the decoding section 10 is divided by the externally specified normalization coefficient (=2.4) and normalization processing is performed.

The audio processing section 30 receives the input channel configuration information G, the output control information (output channel configuration information) Z, and the normalization method instruction information M from the control section 20. In this case, the normalization method instruction information M is “0”, and thus normalization processing using the externally specified coefficient is instructed. Accordingly, the normalization coefficient calculated by the normalization coefficient calculating section 31 is 1.0 and normalization processing is not substantially performed in downmixing performed in the audio processing operation section 32.

As has been described, when the normalization method instruction information M is set to be “0 (external specification)” from the outside, normalization processing is not performed in downmixing performed in the audio processing section 30. However, normalization processing is performed using the externally specified coefficient in the normalization processing section 40 in the previous stage. Thus, it is assumed that normalization has been substantially performed using a normalization coefficient of 2.4.

2) The case where a set value of the normalization method instruction information M is “1 (internal calculation)”

Respective operations in the decoding section 10 and the control section 20 are the same as those in the case where the normalization method instruction information M is “external specification”, the description thereof will be omitted. Only difference is in normalization processing in the normalization processing section 40 and the audio processing section 30.

In this case, the normalization method instruction information M is “1”, and thus normalization processing using an internally calculated coefficient is instructed and normalization processing is performed in the audio processing section 30. Specifically, the audio processing section 30 receives the input channel configuration information G, the output control information (output channel configuration information) Z and the normalization method instruction information M from the control section 20. The normalization method instruction information M is “1”, and thus normalization coefficient is calculated by the normalization coefficient calculation section 31.

The input channel configuration includes 5 channels (L/R/C/LS/RS) and the output channel configuration includes 3 channels (L/R/C). Therefore, downmixing for each output channel is performed according to:

L=L+0.7×LS

R=R+0.7×RS

C=C

LS=0 and

RS=0

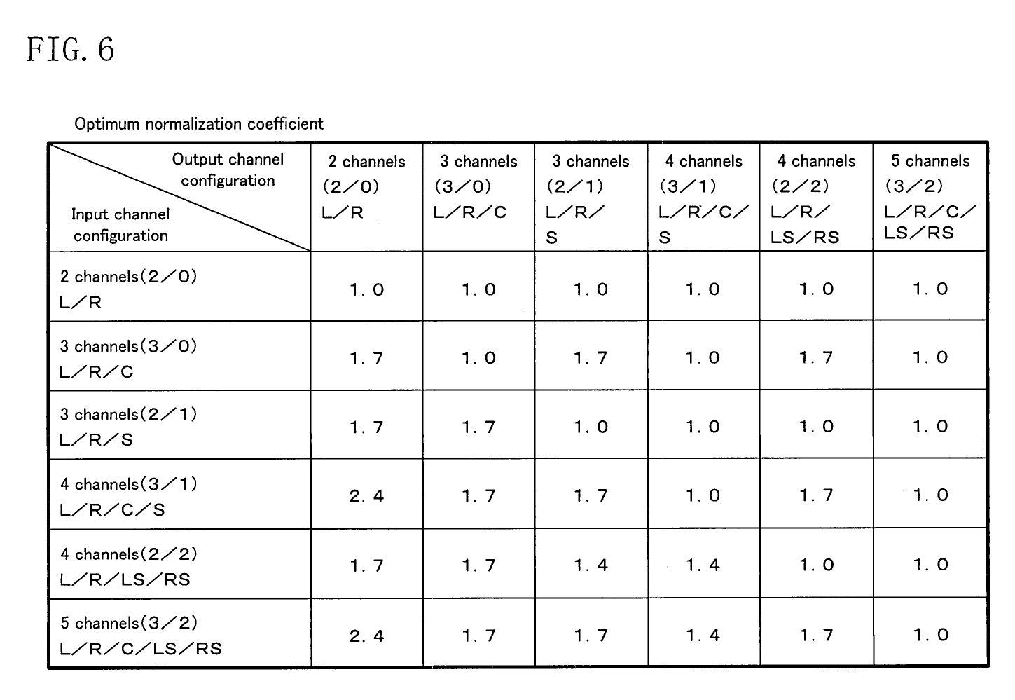

FIG. 6 is a table showing examples of optimal normalization coefficients used in downmixing. To prevent an overflow of each channel and maintain balance among channels, the normalization coefficient becomes “1.7”. In downmixing preformed in the audio processing operation section 32, the entire PCM data input from the normalization processing section 40 is divided by the internally calculated normalization coefficient (=1.7), normalization processing is performed, downmixing is performed, and then the PCM data is output to the outside.

In this embodiment, the input channel configuration has 5 channels but the output channel configuration includes 3 channels (L/R/C), and thus an optimum normalization coefficient itself is “1.7” which is obtained when the normalization method instruction information M is “1” (see FIG. 6). Now, consider the case where a whole system in which the audio decoding device is implemented. When the normalization method instruction information M is “1”, there are various combinations of the input channel configuration and the output channel configuration and a correction value for a volume level which is corrected in a circuit in a later stage of the audio decoding device have to be changed each time. Accordingly, a circuit configuration might be complicated.

In comparison, when the normalization method instruction information M is “0”, the normalization coefficient is fixed to “2.4”. Therefore, a certain level correction is performed in a later stage process step. Moreover, the combination between the input channel configuration and the output channel configuration in which an overflow occurs at the most frequently is a 5 channel input (L/R/C/LS/RS) and a 2 channel output (L/R), and the normalization coefficient at which an attenuation becomes the largest is “2.4” (see FIG. 6). Therefore, to simplify control of level correction value in a later stage process step, with a normalization coefficient of “2.4” set to be a fixed value, normalization processing is performed.

As has been described, according to this embodiment, a normalization method is selected between external specification and internal calculation, based on the normalization method instruction information M. If external specification is selected, normalization processing can be uniformly performed by the normalization processing section 40. As a result, regardless of the input channel and the output control setting, a normalization coefficient can be set fixedly. Therefore, a normalization coefficient can be set in different manner according to the configuration of a decoding system.

For example, when it is desired to control an audio circuit to be connected to an external component in a simple manner, a normalization coefficient can be externally specified so that normalization processing of the audio circuit to be connected to an external component can be omitted. On the other hand, when it is desired to put greater importance to audio quality, internal calculation is selected so that an output signal can be obtained in an optimally normalized state.

### Second Embodiment

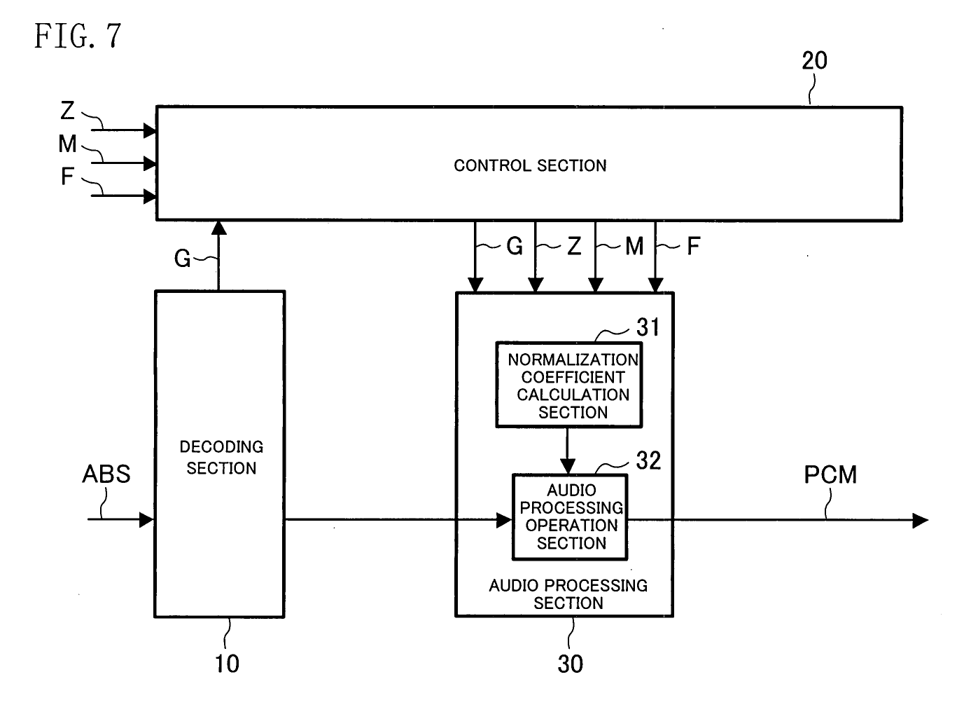

FIG. 7 is a block diagram illustrating an exemplary configuration of an audio decoding device according to a second embodiment of the present invention. The audio decoding device of FIG. 7 includes a decoding section 10, a control section 20 and an audio processing section 30.

The audio decoding device of FIG. 7 differs from the audio decoding device of the first embodiment in the point that the normalization processing section 40 is omitted and the point that the control section 20 and the audio processing section 30 receive different management information. The control section 20 of this embodiment receives, in addition to output control information Z, normalization method instruction information M and externally specified input channel condition information F as information received from the outside. This is also a different point from the first embodiment.

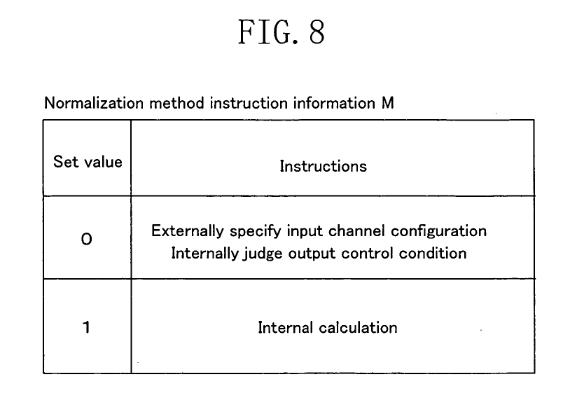

FIG. 8 is a table showing an example of instructions for each set value, specified by the normalization method instruction information M in this embodiment. The normalization method instruction information M indicates which an externally specified condition or input channel configuration information G extracted in the decoding section 10 is used as an input channel condition in performing normalization. The externally specified input channel condition information F indicates an input channel configuration condition to be used when the normalization method instruction information M instructs to use an externally specified condition. The externally specified input channel condition information F is fixedly used, regardless of the input channel configuration information G extracted in the decoding section 10.

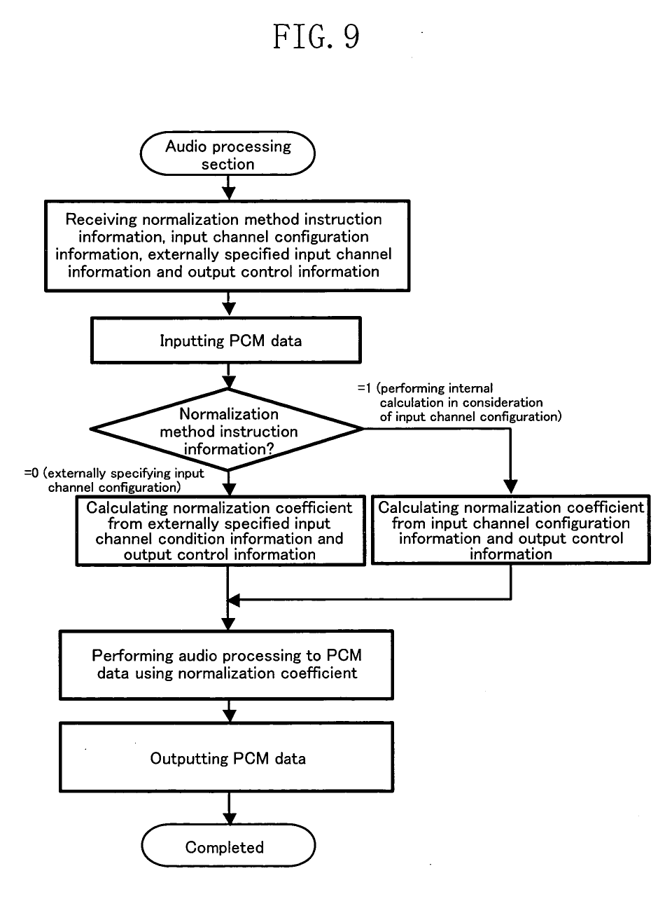

FIG. 9 is a flowchart showing the outline of process steps in the audio processing section 30 of this embodiment. The audio processing section 30 includes a normalization coefficient calculation section 31 and an audio processing operation section 32 inside thereof and receives the input channel configuration information G, the output control information Z, the normalization method instruction information M and the externally specified input channel condition information F from the control section 20. In the audio processing section 30, when the normalization method instruction information M indicates “external specification” as an input channel condition, the externally specified input channel configuration information F and the output control information Z are used, and when the normalization method instruction information M indicates “internal calculation”, a normalization coefficient is calculated using the input channel configuration information G and the output control information Z in the normalization coefficient calculation section 31. Then, an audio processing is performed in the audio processing operation section 32.

According to the audio decoding device of this embodiment, selection of a normalization method by the normalization method instruction information M only depends on the input channel configuration information G. Therefore, normalization processing with respect to an output control setting is performed in the audio processing section 30 without exception.

In general, there are many cases where the channel configuration of an input stream can be extracted by decoding. Also, it is difficult to estimate a normalization coefficient in advance when an audio decoding device is controlled. In such a situation, audio decoding with reduced discomfort in terms of audibility level becomes possible by fixedly setting a normalization coefficient for decoding by a decoding system with the largest number of channels.

Output control information indicates a setting with respect to a speaker configuration. It is very rare to change the setting during playback. In most case, a fixed setting is applied. Therefore, even in a configuration in which a normalization coefficient is automatically calculated by the audio processing section 30, relative change does not occur and thus level correction does not have to be externally performed. Accordingly, an optimum level setting can be achieved in a simple manner by automatically judging only an output control condition.

Thus, normalization processing selection is performed only according to an input condition. Therefore, the audio decoding device of this embodiment can be effectively operated in terms of both of control and audio quality.

### Third Embodiment

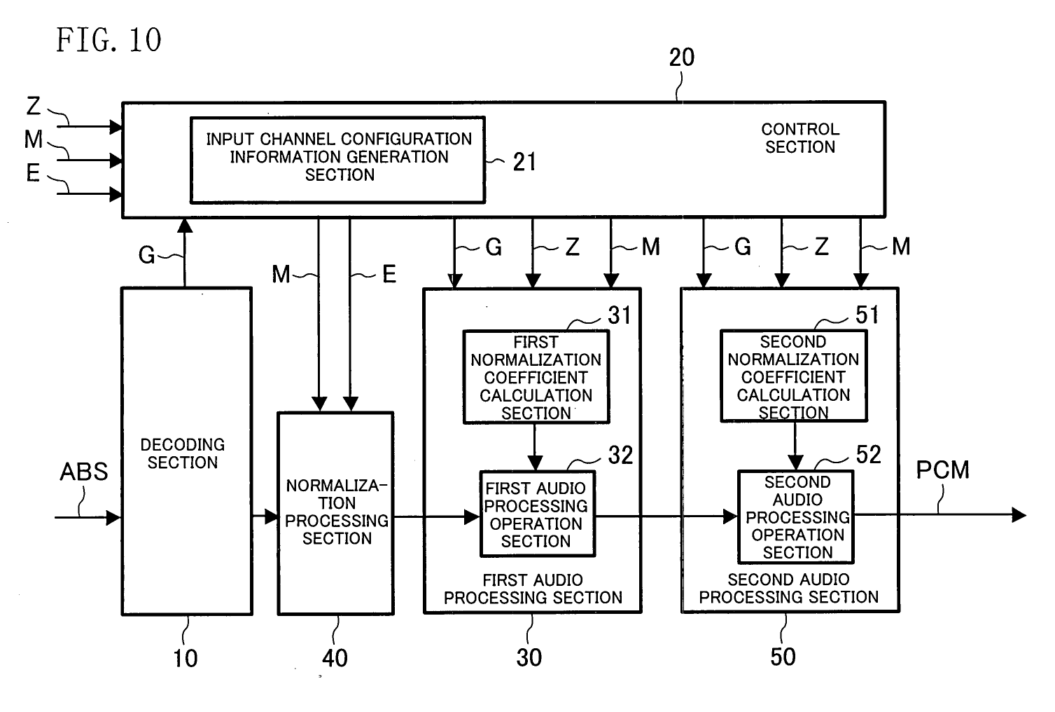

FIG. 10 is a block diagram illustrating an exemplary configuration of an audio decoding device according to a third embodiment of the present invention. The audio decoding device of FIG. 10 includes a decoding section 10, a control section 20, a normalization processing section 40, a first audio processing section 30 and a second audio processing section 50.

As in the first embodiment, the decoding section 10 has the function of decoding an audio bit stream input from the outside to generate PCM data, outputting the PCM data to the normalization processing section 40 and transmitting, as input channel configuration information G, channel configuration information corresponding to the decoded PCM data obtained from header information analysis or like processing in decoding the audio bit stream to the control section 20.

The control section 20 has the function of receiving output control information Z, normalization method instruction information M and externally specified normalization coefficient information E from the outside and input channel configuration information G from the decoding section 10 and transmitting the received information to the first and second audio processing sections 30 and 50. The control section 20 is so configured to include an input channel configuration information generation section 21 inside thereof. The output control information Z and the externally specified normalization coefficient information E are the same as those of the first embodiment and therefore the description thereof will be omitted. Although the normalization method instruction information M is also the same as that of the first embodiment, the normalization method instruction information M corresponds to each of the first and second audio processing sections 30 and 50 and a set value is extended by 1 bit and thus expressed by 2 bits.

The input channel configuration information generation section 21 has the function of generating input channel configuration information G for each of the audio processing sections 30 and 50. For example, the input channel configuration of PCM data to the second audio processing section 50 is changed according to processing of the first audio processing section 30 and thus is calculated based on the input channel configuration information G received from the decoding section 10 and the output control information Z externally specified.

The normalization processing section 40 has the function of receiving the normalization method instruction information M and the external specified normalization coefficient information E from the control section 20 and performing normalization processing to the PCM data output from the decoding section 10 according to an instruction given by the normalization method instruction information M.

The first audio processing section 30 is configured so as to include a first normalization coefficient calculation section 31 and a first audio processing operation section 32 inside thereof. The first audio processing section 30 has the function of receiving the input channel configuration information G, the output control information Z and the normalization method instruction information M from the control section 20, calculating, if the normalization method instruction information M indicates internal calculation of a normalization coefficient, a normalization coefficient in the first normalization coefficient calculation section 31 and performing audio processing in the first audio processing operation section 32.

As the first audio processing section 30, the second audio processing section 50 is configured so as to include a second normalization coefficient calculation section 51 and a second audio processing operation section 52 inside thereof. The second audio processing section 50 has the function of receiving the input channel configuration information G, the output control information Z and the normalization method instruction information M from the control section 20, calculating, if the normalization method instruction information M indicates internal calculation of a normalization coefficient, a normalization coefficient in the second normalization coefficient calculation section 51 and performing audio processing in the second audio processing operation section 52.

A unique audio processing operation is allocated to each of the first and second audio processing sections 30 and 50.

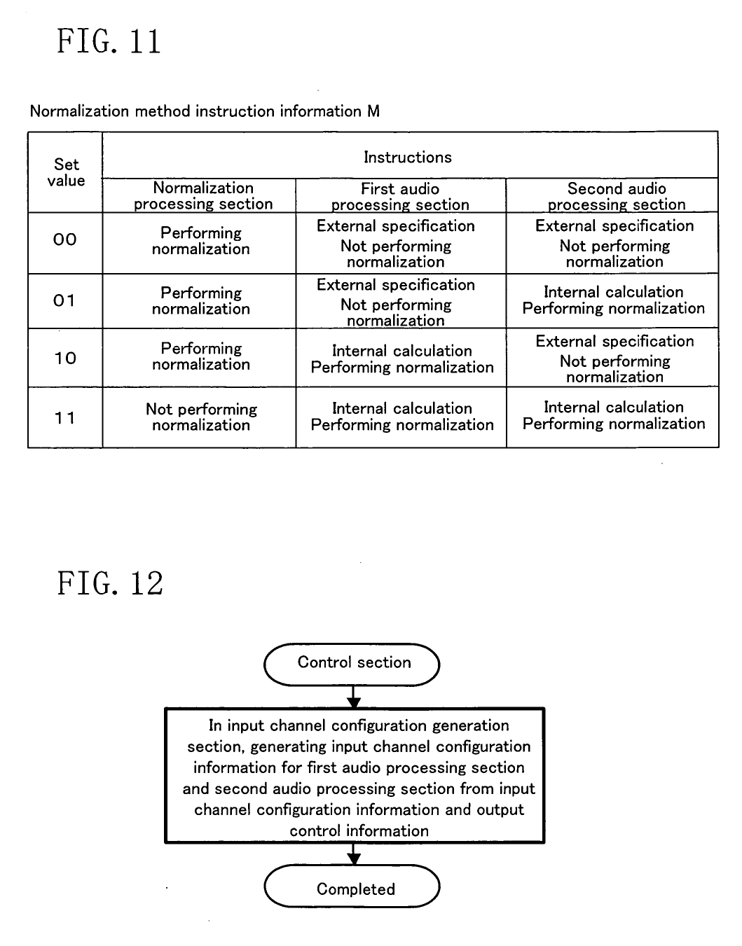

FIG. 11 is a table showing an example of instructions for each set value, specified by the normalization method instruction information M in this embodiment.

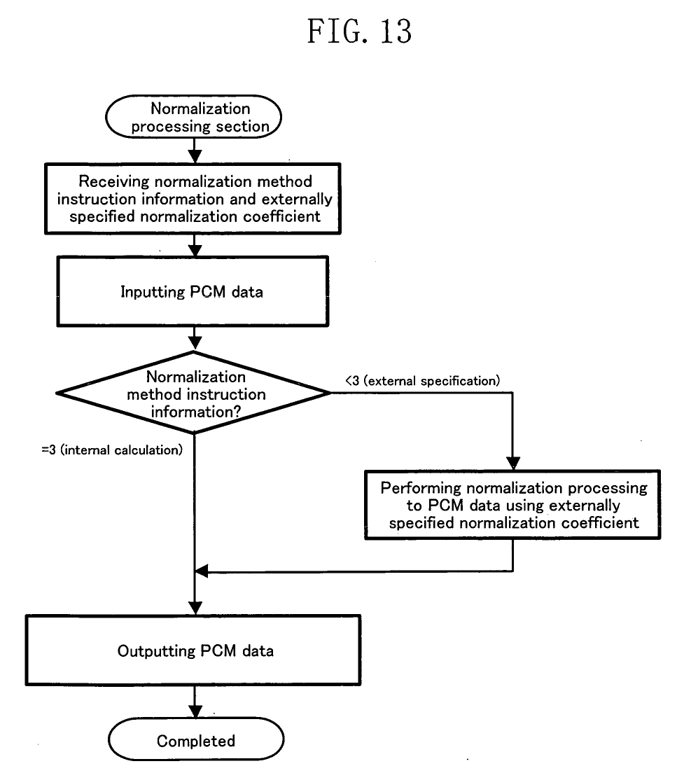

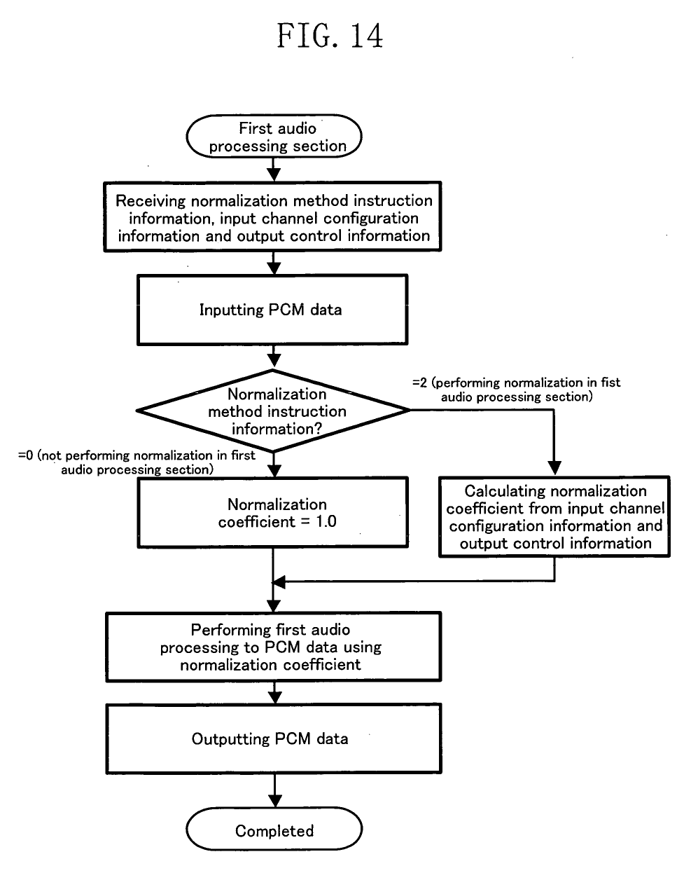

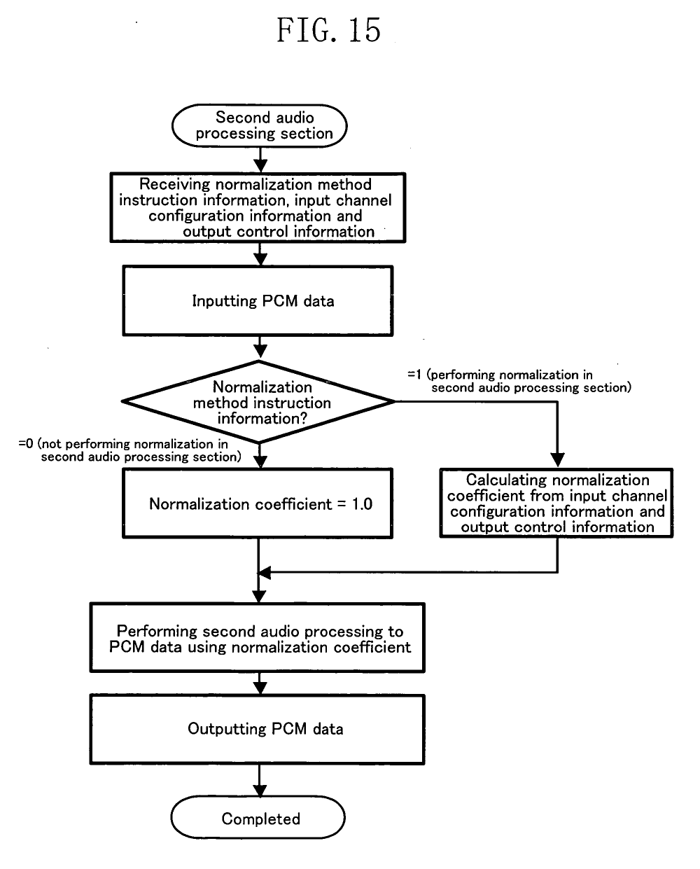

FIGS. 12 through 15 are flowcharts showing the outline of process steps according to this embodiment. FIG. 12 shows process steps performed by the control section 20. FIG. 13 shows process steps performed by the normalization processing section 40. FIG. 14 shows process steps performed by the first audio processing section 30. FIG. 15 shows process steps performed by the second audio processing section 50.

The operation of the audio decoding device configured so as to have the above-described configuration will be described for the following cases:

the case where a set value of the normalization method instruction information M is “00”

the case where a set value of the normalization method instruction information M is “01”

the case where a set value of the normalization method instruction information M is “11” with reference to the flowcharts of FIGS. 12 through 15.

1) The case where a set value of the normalization method instruction information M is “00”

First, as in the first embodiment, in the decoding section 10, an audio bit stream input from the outside is decoded to generate PCM data. The channel configuration of the decode PCM data is obtained from header information analysis or like processing in decoding the audio bit stream and is transmitted as the input channel configuration information G to the control section 20. The decoded PCM data is output to the normalization processing section 40.

The control section 20 receives the output control information Z, the normalization method instruction information M and the externally normalization coefficient information E from the control section 20 and the input channel configuration G from the decoding section 10.

In the input channel configuration information generation section 21, from the input channel configuration information G and the output control information Z, input channel configuration information G to be transmitted to each of the first audio processing section 30 and the second audio processing section 50 is generated. For example, if the first audio processing section 30 has the function of outputting 2 channel (L/R) data, regardless of an input channel configuration immediately after decoding, an input channel configuration to the second audio processing section 50 is a 2 channel (L/R) configuration, regardless of an input channel configuration immediately after decoding.

After the input channel configuration information G for each of the audio processing sections 30 and 50 has been generated by the input channel configuration information generation section 21, the control section 20 transmits the output control information Z, the normalization method instruction information M, the externally specified normalization coefficient information E, and the input channel configuration information G to the normalization processing section 40 and the audio processing section 30.

In the normalization processing section 40, the normalization method instruction information M and the externally specified normalization coefficient information E are received from control section 20. In this case, the normalization method instruction information M is “00”, and thus, as shown in FIG. 11, normalization processing using an externally specified coefficient is instructed. Accordingly, in the normalization processing section 40, the entire PCM data input from the decoding section 10 is divided by an externally specified normalization coefficient and normalization processing is performed.

The first audio processing section 30 receives the input channel configuration information G for the first audio processing section 30, the output control information Z and the normalization method instruction information M from the control section 20. In this case, the normalization method instruction information M is “00”, and thus it is assumed that normalization processing to the first audio processing section 30 has been performed by the normalization processing section 40. Thus, a normalization coefficient calculated by the first normalization coefficient calculation section 31 becomes 1.0, so that normalization processing is not substantially performed in an audio processing operation performed in the first audio processing operation section 32.

Next, in the second audio processing section 50, the input channel configuration information G for the second audio processing section 50, the output control information Z and the normalization method instruction information M are received from the control section 20. In this case, as in the first audio processing section 30, a normalization coefficient calculated by the second normalization coefficient calculation section 31 becomes 1.0, so that normalization processing is not substantially performed in an audio processing operation performed in the second audio processing operation section 52.

As has been described, when the normalization method instruction information M is set to be “00 (external specification for each of the first and second audio processing section 30 and 50)” from the outside, normalization processing is not performed in each of the first and second audio processing sections 30 and 50 but performed using an externally specified coefficient in the normalization processing section 40 in a previous stage process step. Thus, normalization processing using an externally specified normalization coefficient is substantially performed.

Furthermore, in this case, a fixed, externally specified and normalization coefficient is used. Therefore, level correction does not have to be performed in a circuit connected in a later stage in the audio decoding device.

2) The case where a set value of the normalization method instruction information M is “01”

Respective operations of the decoding section 10 and the control section 20 are the same as those in the case where a set value of the normalization method instruction information M is “00”, and therefore the description thereof will be omitted.

In the normalization processing section 40, the normalization method instruction information M and the externally specified normalization coefficient information E are received from the control section 20. In this case, the normalization method instruction information M is “01”, and thus, as shown in FIG. 11, normalization processing using an externally specified coefficient is instructed. Accordingly, the entire PCM data input from the decoding section 10 is divided by the externally specified normalization coefficient in the normalization processing section 40 and normalization processing is performed.

The first audio processing section 30 receives the input channel configuration information G for the first audio processing section 30, the output control information Z and the normalization method instruction information M from the control section 20. In this case, the normalization method instruction information M is “01”, and thus it is assumed that normalization processing to the first audio processing section 30 has been performed by the normalization processing section 40. Accordingly, a normalization coefficient calculated by the first normalization coefficient calculation section 31 becomes 1.0, so that normalization processing is not substantially performed in audio processing operation performed in the first audio processing operation section 32.

In the second audio processing section 50, the input channel configuration information G for the second audio processing section 50, the output control information Z and the normalization method instruction information M are received from the control section 20. In this case, the normalization method instruction information M is “01”, and thus a normalization coefficient is calculated by the second normalization coefficient calculation section 51. For example, assume that in the second audio processing operation section 52, an adding operation is performed according to:

L=L+0.7×LS

R=R+0.7×RS

In this case, the normalization coefficient has to be “1.7” in order to avoid an overflow.

As has been described, when the normalization method instruction information M is set to be “01 (external specification for the first audio processing section 30 and internal operation for the second audio processing section 50)” from the outside, normalization processing is performed in the second audio processing section 50 but not in the first audio processing section 30. However, normalization processing performed using an externally specified coefficient in the normalization processing section 40 in a previous stage process step is substantially normalization processing to the first audio processing section 30.

Furthermore, in this case, a fixed, externally specified and normalization coefficient is used for the first audio processing section 30. Therefore, level correction does not have to be performed in a circuit to be connected in a later stage in the audio decoding device.

Moreover, for the second audio processing section 50, there might be cases where a normalization coefficient varies according to an input channel configuration and an output control setting. For example, if a normalization coefficient varies according to an output control setting only at the time of initial setting of a speaker configuration condition of speakers to be connected to be external components and the like and setting change is not performed during playback, normalization for preventing an overflow can be optimally performed and thus a more effective function can be achieved. In such a case, a volume level is not influenced by mode switching during playback and the like.

3) The case where a set value of the normalization method instruction information M is “11”

Respective operations of the decoding section 10 and the control section 20 are the same as those when a set value of the normalization method instruction information M is “11” and also those when the set value is “01”, and therefore the description thereof will be omitted.

In the normalization processing section 40, normalization method instruction information M and externally specified normalization coefficient information E are received from the control section 20. In this case, the normalization method instruction information M is “11”, and thus, as shown in FIG. 11, normalization processing is not performed.

The first audio processing section 30 receives input channel configuration information G, output control information Z and normalization method instruction information M. In this case, the normalization instruction information M is “11”, and thus a normalization coefficient is calculated by the first normalization coefficient calculation section 31. Furthermore, normalization processing using a normalization coefficient calculated by the first normalization coefficient calculation section 31 is performed in an audio processing operation performed in the first audio processing operation section 32. In the same manner, in the second audio processing section 50, the normalization method instruction information M is “11”, and thus a normalization coefficient is calculated by the second normalization coefficient calculation section 51.

As has been described, when the normalization method instruction information M is set to be “11 (internal operation for each of the first and second audio processing section 30 and 50) from the outside, normalization processing using an internally calculated coefficient is performed in each of the first and second audio processing sections 30 and 50.

In this case, it is estimated that the normalization coefficient for each of the first audio processing section 30 and the second audio processing section 50 is changed according to an input channel configuration and an output control setting. Therefore, specifically, in mode setting switching during playback and the like, a need of performing level correction in a circuit or the like in a later stage process step arises. However, normalization with respect to prevention of an overflow is optimally performed. Accordingly, an optimum S/N for this embodiment can be achieved. For a system in which real-time level correction is possible in a circuit or the like in a later stage process step, this is the most effective set value.

As has been described, in the audio decoding device of the third embodiment, a normalization method can be set for each audio processing section. Thus, a normalization processing instruction can be optimally set for each function of each audio processing section according to convenience of a system in which the audio decoding device is implemented.

For example, a setting for a speaker channel configuration and bass management can be changed only at the time of initial setting and thus the fixed setting is used during playback. For such functions, it is advantageous in terms of S/N that in an internal audio processing section, a normalization coefficient is automatically calculated and normalization is performed. Also, change in volume level for each playback medium or other discomforts are not caused.

However, if internal normalization processing is automatically performed to a system in which setting change is performed during playback with a sound-field processing or the like, a normalization condition is changed for each playback medium. Accordingly, there might be cases where a volume level is changed and discomfort is given unless level correction is performed in an analog circuit or the like in a later stage process step. If such a case is taken into consideration, for example, external processing is performed exclusively to functions in which setting change is performed during playback according to conditions which tend to cause an overflow most frequently, so that an optimal level setting can be achieved without complicating control of an analog circuit or the like in a later stage.

Thus, optimum normalization processing can be performed to basic audio processing settings and a fixed setting can be used only for level setting which depends on audio processing during playback. Therefore, level control of the audio decoding device can be performed in a simple manner.

In this embodiment, two audio processing sections have been described for the sake of simplification. However, needless to say, an audio decoding device including three or more audio processing sections has the same effects as those described above. In such a case, a bit length of the normalization method instruction information M is extended according to the number of audio processing sections to be controlled.

### Fourth Embodiment

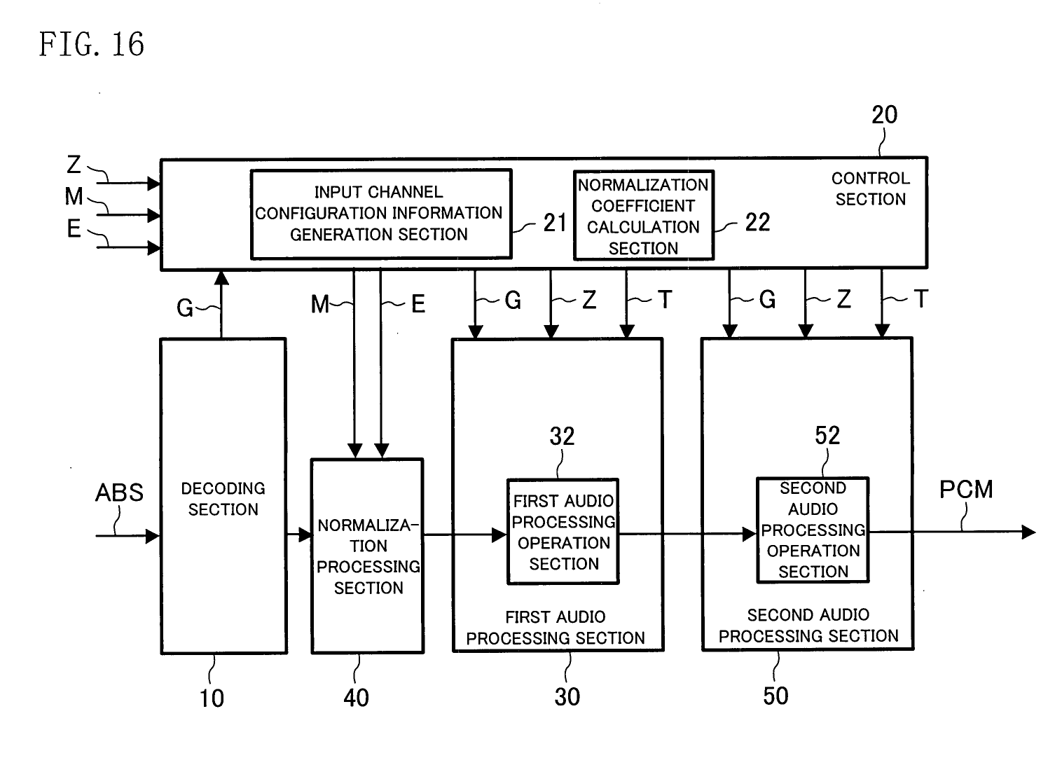

FIG. 16 is a block diagram illustrating an exemplary configuration of an audio decoding device according to a fourth embodiment of the present invention. As in the third embodiment, the audio decoding device of FIG. 16 includes a decoding section 10, a control section 20, a normalization processing section 40, a first audio processing section 30 and a second audio processing section 50. Also, in this embodiment, the normalization method instruction information M of FIG. 11 is used as in the third embodiment.

The audio decoding device of FIG. 16 is different from the audio decoding device of the third embodiment in the point that normalization coefficient calculation sections 31 and 51 are provided in a control section 20 unlike the third embodiment in which the normalization coefficient calculation sections 31 and 51 are provided in the first and second audio processing sections 30 and 50, respectively, and the point that information to be transmitted from the control section 20 to the first and second audio processing sections 30 and 50 includes normalization coefficient information T.

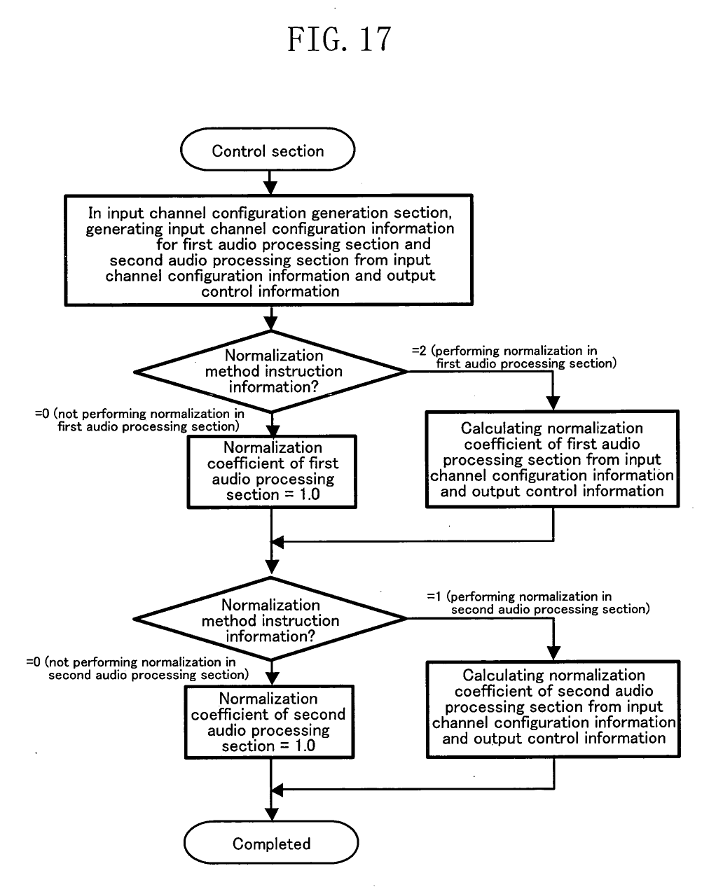

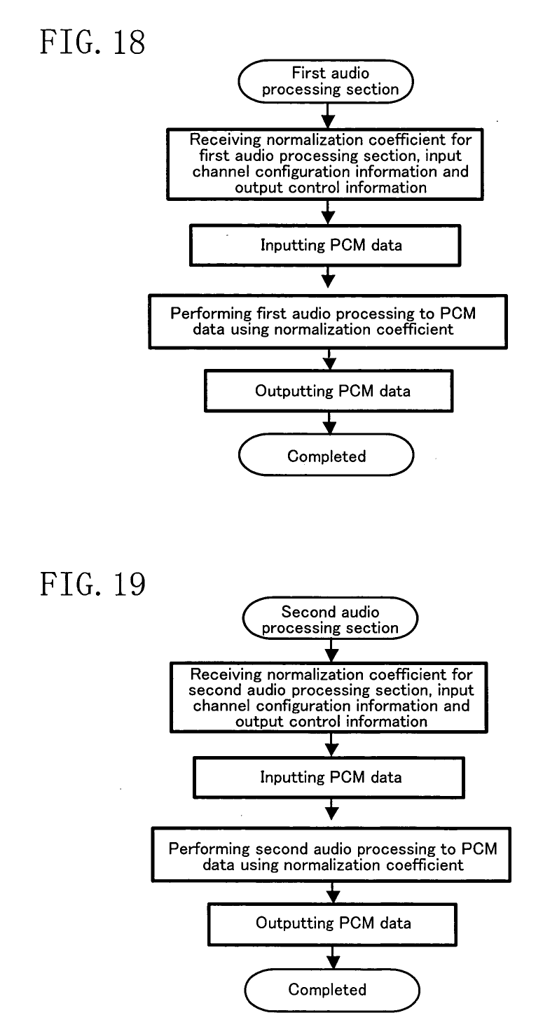

FIGS. 17 through 19 are flowcharts showing the outline of process steps according to this embodiment. FIG. 17 shows process steps performed by the control section 20. FIG. 18 shows process steps performed by the first audio processing section 30. FIG. 19 shows process steps performed by the second audio processing section 50.

Differences of process steps performed by the audio decoding device of this embodiment from those by the audio decoding device of the third embodiment are only the following two points. First, calculation of a normalization coefficient for each of the first audio processing section 30 and the second audio processing section 50 is performed in a process flow of the control section 20 of FIG. 17. Second, calculation of a normalization coefficient is omitted in a process flow of each of FIGS. 18 and 19.

According to the audio decoding device of this embodiment, compared to the audio decoding device of the third embodiment, normalization coefficient calculation is comprehensively performed in the control section 20. Thus, the whole processing of the decoding system can be optimized.

Specifically, assume that an audio decoding device according to the present invention is implemented by a program provided in a digital signal processor or a system LSI. According to the fourth embodiment, respective normalization processings for the first and second processing sections 30 and 50 are performed in the control section 20. In this configuration, compared to the case where a normalization coefficient is calculated separately in the first and second audio processing sections 30 and 50, normalization processing can be optimized. More specifically, a sub program is shared, thus reducing a program instruction memory. Processings of the first and second audio processing sections 30 and 50 are performed together, thus reducing a work memory. Also, the number of process steps to be executed can be reduced.

As has been described, with an audio decoding device according to the present invention, an optimum audio decoding device can be achieved according to a system configuration and cost conditions only by changing normalization processing settings. Therefore, the audio decoding device of the present invention is useful as a system for performing various audio processings to output PCM data to the outside.

What is claimed is:

1. An audio decoding device with a normalization function of uniformly attenuating PCM data of all channels in order to prevent audio quality degradation due to an overflow, the device comprising:
a normalization processing section for receiving normalization method instruction information indicating which an externally specified normalization coefficient or an internally calculated normalization coefficient is used to perform normalization and externally specified normalization coefficient information when the normalization method instruction information indicates external specification, and performing volume normalization processing to the PCM data, and
an audio processing section for receiving the normalization method instruction information, input channel configuration information indicating a channel configuration of the PCM data and output control information indicating conditions for decoding the PCM data, and performing audio processing to the PCM data output from the normalization processing section,
wherein the normalization processing section performs normalization processing using the externally specified normalization coefficient, when the normalization method instruction information indicates external specification, and
wherein the audio processing section performs normalization processing using the input channel configuration information and the output control information, when the normalization method instruction information indicates internal calculation.

2. The audio decoding device of claim 1, wherein the audio processing section includes: a normalization coefficient calculation section for calculating, when the normalization method instruction information indicates internal calculation, a normalization coefficient using the input channel configuration information and the output control information; and an operation section for performing, when the normalization method instruction information indicates internal calculation, an audio processing operation using a normalization coefficient calculated by the normalization coefficient calculation section.

3. An audio decoding device with a normalization function of uniformly attenuating PCM data of all channels in order to prevent audio quality degradation due to an overflow, the device comprising:
a decoding section for decoding an audio bit stream to generate PCM data and outputting a channel configuration of the generated PCM data as input channel configuration information;
a control section for receiving the input channel configuration information, normalization method instruction information indicating which an externally specified normalization coefficient or an internally calculated normalization coefficient is used to perform normalization, externally specified normalization coefficient information used when the normalization method instruction information indicates external specification and output control information indicating conditions for decoding the PCM data and controlling internal processing;
a normalization processing section for receiving the normalization method instruction information and the externally specified normalization coefficient information from the control section and performing volume normalization to the PCM data output from the normalization processing section; and
an audio processing section for receiving the normalization method instruction information, the input channel configuration information and the output control information from the control section, and performing audio processing to the PCM data output from the decoding section,
wherein the normalization processing section performs normalization processing using the externally specified normalization coefficient, when the normalization method instruction information indicates external specification, and
wherein the audio processing section performs normalization processing using the input channel configuration information and the output control information, when the normalization method instruction information indicates internal calculation.

4. The audio decoding device of claim 3, wherein the audio processing section includes: a normalization coefficient calculation section for calculating a normalization coefficient using the input channel configuration information and the output control information, when the normalization method instruction information indicates internal calculation; and an operation section for performing an audio processing operation using a normalization coefficient calculated by the normalization coefficient calculation section, when the normalization method instruction information indicates internal calculation.

5. The audio decoding device of claim 3, wherein the audio decoding device includes at least two audio processing sections,
wherein the normalization method instruction information is audio processing section normalization instruction information indicating whether or not internal calculation of a normalization coefficient and normalization processing to be performed in each of the audio processing sections,
wherein the control section includes an input channel configuration information generation section for generating input channel configuration information for each of the audio processing sections,
wherein the normalization processing section performs normalization processing using the externally specified normalization coefficient information, when the audio processing section normalization instruction information indicates that normalization processing is not to be performed in at least one of the audio processing sections, and
wherein each of the audio processing sections performs normalization processing using the input channel configuration information and the output control information, when the audio processing section normalization instruction information indicates that normalization processing is to be performed in each of the audio processing sections.

6. The audio decoding device of claim 5, wherein the control section includes a normalization coefficient calculation section for calculating a normalization coefficient for each of the audio processing sections, and
wherein each of the audio processing sections performs audio processing using a normalization coefficient calculated by the normalization coefficient calculation section.

7. An audio decoding device with a normalization function of uniformly attenuating PCM data of all channels in order to prevent audio quality degradation due to an overflow, the device comprising:
a decoding section for decoding an audio bit stream to generate PCM data and outputting a channel configuration of the generated PCM data as input channel configuration information;
a control section for receiving the input channel configuration information, normalization method instruction information indicating which in performing normalization, an input channel condition is externally specified or the input channel configuration information is used, externally specified input channel condition information used when the normalization method instruction information indicates external specification and output control information indicating conditions for decoding the PCM data and controlling internal processing; and
an audio processing section for receiving the normalization method instruction information, the externally specified input channel condition information, the input channel configuration information and the output control information from the control section and performing an audio processing to the PCM data output from the normalization processing section,
wherein the audio processing section performs normalization processing using the externally specified input channel condition information and the output control information when the normalization method instruction information indicates external specification, and performs normalization processing using the input channel configuration information and the output control information when the normalization method instruction information indicates internal calculation.

8. The audio decoding device of claim 7, wherein the audio processing section includes: a normalization coefficient calculation section for calculating a normalization coefficient using the externally specified input channel condition information and the output control information when the normalization method instruction information indicates external specification, and a normalization coefficient using the input channel configuration information and the output control information when the normalization method instruction information indicates internal calculation; and an operation section for performing an audio processing operation using a normalization coefficient calculated by the normalization coefficient calculation section.
